(19) United States
(12) Patent Application Publication
(10) Pub. No.: US 2014/0307597 A1
(43) Pub. Date: Oct. 16, 2014

(54) METHOD AND APPARATUS FOR CONTROLLING TRANSCEIVING OF PHYSICAL CHANNELS IN TIME DIVISION DUPLEX COMMUNICATION SYSTEM

(71) Applicant: Samsung Electronics Co., Ltd., Suwon-si, Gyeonggi-do (KR)

(72) Inventors: Young-Bum Kim, Seoul (KR); Joon-Young Cho, Gyeonggi-do (KR); Youn-Sun Kim, Gyeonggi-do (KR); Hyoung-Ju Ji, Seoul (KR); Seung-Hoon Choi, Gyeonggi-do (KR)

(21) Appl. No.: 14/359,076

(22) PCT Filed: Nov. 19, 2012
(86) PCT No.: PCT/KR2012/009790

§ 371 Date: May 16, 2014

(30) Foreign Application Priority Data
Nov. 17, 2011 (KR) 10-2011-0120490
Dec. 1, 2011 (KR) 10-2011-0127506

(51) Int. Cl. H04L 5/14; H04B 7/26; H04L 5/00

(52) U.S. Cl. CPC H04L 5/14; H04L 5/0055; H04B 7/2643
USPC 370/280

(57) ABSTRACT

Disclosed are a method and an apparatus for controlling the transceiving of physical channels in a time division duplex (TDD) communication system. The method comprises: a step of determining whether a point of time of HARQ ACK/NACK transmission in component carrier #1 and a point of time of the transmission of another signal in component carrier #2 coupled with the component carrier #1 are overlapped with each other; and a step of preferentially transmitting or receiving a HARQ ACK/NACK signal when the points of time of transmission are overlapped with each other. Thus, the method and the apparatus of the present invention may prevent transceiving error or transmission delay of data or a control channel.

### TECHNICAL FIELD

The present invention relates to a cellular radio communication system, and more particularly, to a method and an apparatus for transceiving physical channels in a time division duplex (TDD) communication system that supports carrier aggregation.

### BACKGROUND ART

A radio communication system, for example, has been developed to a broadband radio communication system, which provides a high quality high speed packet data service as well as an initial voice-centered service, as with a communication standard such as HSPA (High Speed Packet Access) of 3GPP (3^{rd} Generation Partnership Project), LTE (Long Term Evolution), HRPD (High Rate Packet Data) of 3GPP2, UMB (Ultra Mobile Broadband), or 802.16E of IEEE.

In an LTE system that is a representative example of the broadband radio communication system, an OFDM (Orthogonal Frequency Division Multiplexing) scheme is employed in a downlink and a SC-FDMA (Single Carrier Frequency Division Multiple Access) scheme is employed in an uplink. In the multiplexing access scheme as described above, time-frequency resources for sending data or control information by a user are typically assigned and operated such that the time-frequency resources are not overlapped with each other, that is, orthogonality is established, so that the data or control information of each user is distinguished from each other.

A TDD (time division duplex) system uses a frequency common in a downlink and an uplink, and the transceiving of uplink signals and the transceiving of downlink signals are separately operated in a time domain. In LTE and LTE-A TDD, uplink signals or downlink signals are separately transmitted by a subframe that is a unit of a time domain. Subframes for an uplink and a downlink may be uniformly divided and operated in a time domain, many more subframes may be assigned to and operated for the downlink, or many more subframes may be assigned to and operated for the uplink according to traffic load of the uplink and the downlink.

In the TDD system, since downlink or uplink signal transmission is permitted only for a specific time slot, it is necessary to define in detail a timing relation among uplink and downlink physical channels in a mutual relation such as a control channel for data scheduling, a scheduled data channel, or a HARQ (Hybrid Automatic Retransmission Request) ACK/NACK channel corresponding to the data channel.

Furthermore, when a timing relation among physical channels of an LTE TDD system is applied to an LTE-A system that supports carrier aggregation, it is necessary to define an additional operation in addition to the timing relation. Particularly, it is necessary to define a detailed method for a half-duplex operation in which a terminal can perform only one of downlink signal reception and uplink signal transmission operations in one transmission time slot. In detail, in the situation in which a specific time slot has been set as a downlink subframe or a special subframe in a predetermined component carrier and has been set as an uplink subframe in another component carrier coupled with the predetermined component carrier, it is necessary to define a method in which a terminal employing a half-duplex operation receives a downlink signal or transmits an uplink signal in the time slot.

### DISCLOSURE OF INVENTION

### Technical Problem

The invention has been made to solve the above-mentioned problem in the prior art, and an aspect of the present invention is to provide a method and an apparatus for transceiving signals in a communication system.

Another aspect of the present invention is to provide a method and an apparatus for transceiving a data channel and a control channel through carrier aggregation (CA) in a broadband TDD radio communication system.

Another aspect of the present invention is to provide a method and an apparatus for determining a communication direction (an uplink or a downlink) of a half-duplex terminal when TDD uplink and downlink configurations of coupled carriers differ by a carrier in a TDD radio communication system.

### Means to Solve the Problem

In accordance with an aspect of the present invention, a method for controlling transceiving of a physical channel in a time division duplex (TDD) communication system includes the steps of: determining whether a point of time of transmission of hybrid automatic retransmission request (HARQ) ACK/NACK in a component carrier #1 and a point of time of transmission of another signal in a component carrier #2 coupled with the component carrier #1 are overlapped with each other; and preferentially transmitting or receiving the HARQ ACK/NACK when the points of time of transmission are overlapped with each other.

In accordance with an aspect of the present invention, a method for controlling transceiving of a physical channel in a time division duplex (TDD) communication system includes the steps of: determining whether a point of time of transmission of uplink HARQ ACK/NACK and a point of time of reception of downlink HARQ ACK/NACK are overlapped with each other; and preferentially transmitting the uplink HARQ ACK/NACK when the points of time of transmission are overlapped with each other.

In accordance with an aspect of the present invention, a method for controlling transceiving of a physical channel in a time division duplex (TDD) communication system includes the steps of: determining whether a point of time of transmission of a physical downlink control channel (PDCCH) for scheduling a physical uplink shared channel (PUSCH) in a component carrier #1 and a point of time of transmission of a PUSCH in a component carrier #2 coupled with the component carrier #1 are overlapped with each other; and preferentially transmitting the PUSCH of the component carrier #2 when the points of time of transmission are overlapped with each other and the PDCCH of the component carrier #1 schedules initial transmission of the PUSCH of the component carrier #1.

In accordance with an aspect of the present invention, a method for controlling transceiving of a physical channel in a time division duplex (TDD) communication system includes the steps of: determining whether a point of time of transmission of a PDCCH, which is a downlink control channel for scheduling a PUSCH in a component carrier #1 and a point of time of transmission of a PUSCH, which is an uplink data channel, in a component carrier #2 coupled with the component carrier #1 are overlapped with each other; and comparing a point of time of transmission of a PDCCH having initially scheduled the PUSCH of the component carrier #1 with a point of time of transmission of a PDCCH having initially scheduled the PUSCH of the component carrier #2, and receiving or transmitting a signal of a component carrier corresponding to an advanced point of time or a recent point of time when the points of time of transmission are overlapped with each other and the PDCCH of the component carrier #1 schedules retransmission of the PUSCH of the component carrier #1.

In accordance with an aspect of the present invention, a method for controlling transceiving of a physical channel in a time division duplex (TDD) communication system includes the steps of: determining whether a point of time of transmission of a random access channel (RACH) or a scheduling request (RS) in a component carrier #1 and a point of time of reception of a downlink signal in a component carrier #2 are overlapped with each other; and transmitting the RACH or the SR of the component carrier #1 when the points of time are overlapped with each other.

In accordance with an aspect of the present invention, an apparatus for controlling transceiving of a physical channel in a time division duplex (TDD) communication system includes: a controller that determines whether a point of time of transmission of hybrid automatic retransmission request (HARQ) ACK/NACK in a component carrier #1 and a point of time of transmission of another signal in a component carrier #2 coupled with the component carrier #1 are overlapped with each other; and a transceiving unit that preferentially transmits or receives the HARQ ACK/NACK when the points of time of transmission are overlapped with each other.

In accordance with an aspect of the present invention, an apparatus for controlling transceiving of a physical channel in a time division duplex (TDD) communication system includes: a controller that determines whether a point of time of transmission of uplink HARQ ACK/NACK and a point of time of reception of downlink HARQ ACK/NACK are overlapped with each other; and a transceiving unit that preferentially transmits the uplink HARQ ACK/NACK when the points of time of transmission and reception are overlapped with each other.

In accordance with an aspect of the present invention, an apparatus for controlling transceiving of a physical channel in a time division duplex (TDD) communication system includes: a controller that determines whether a point of time of transmission of a physical downlink control channel (PDCCH) for scheduling a physical uplink data channel (PUSCH) in a component carrier #1 and a point of time of transmission of a PUSCH in a component carrier #2 coupled with the component carrier #1 are overlapped with each other; and a transceiving unit that preferentially transmits the PUSCH of the component carrier #2 when the points of time of transmission are overlapped with each other and the PDCCH of the component carrier #1 schedules initial transmission of the PUSCH of the component carrier #1.

In accordance with an aspect of the present invention, an apparatus for controlling transceiving of a physical channel in a time division duplex (TDD) communication system includes: a controller that determines whether a point of time of transmission of a PDCCH, which is a downlink control channel for scheduling a PUSCH in a component carrier #1 and a point of time of transmission of a PUSCH, which is an uplink data channel, in a component carrier #2 coupled with the component carrier #1 are overlapped with each other; and a transceiving unit that compares a point of time of transmission of a PDCCH having initially scheduled the PUSCH of the component carrier #1 with a point of time of transmission of a PDCCH having initially scheduled the PUSCH of the component carrier #2, and receives or transmits a signal of a component carrier corresponding to an advanced point of time or a recent point of time when the points of time of transmission are overlapped with each other and the PDCCH of the component carrier #1 schedules retransmission of the PUSCH of the component carrier #1.

In accordance with an aspect of the present invention, an apparatus for controlling transceiving of a physical channel in a time division duplex (TDD) communication system includes: a controller that determines whether a point of time of transmission of a random access channel (RACH) or a scheduling request (RS) in a component carrier #1 and a point of time of reception of a downlink signal in a component carrier #2 are overlapped with each other; and a transceiving unit that transmits the RACH or the SR of the component carrier #1 when the points of time are overlapped with each other.

### Advantageous Effect

In accordance with the disclosed embodiments of the present invention, in a TDD radio communication system achieving a broadband through carrier aggregation, a transmission scheme of physical channels for data or control information transmission is defined to prevent a transceiving error or transmission delay of data or a control channel.

### BRIEF DESCRIPTION OF DRAWINGS

FIG. 1 is a diagram illustrating one example of scheduling of downlink data in a radio communication system;

FIG. 2 is a diagram illustrating a detailed example for a cross carrier scheduling operation;

FIG. 3 is a diagram illustrating a timing of uplink HARQ ACK/NACK for a PDSCH in a TDD radio communication system;

FIG. 4 is a diagram illustrating a timing relation of a PHICH corresponding to an uplink PUSCH in a TDD communication system;

FIG. 5 is a diagram illustrating a transceiving relation of a half-duplex terminal when TDD uplink and downlink configurations of coupled carriers differ by a carrier according to one embodiment of the present invention;

FIG. 6 to FIG. 10 are flowcharts illustrating operations for determining transmission priority of physical channels according to one embodiment of the present invention;

FIG. 11 is a diagram illustrating a base station device according to one embodiment of the present invention; and

FIG. 12 is a diagram illustrating a terminal device according to one embodiment of the present invention.

### BEST MODE FOR THE INVENTION

Hereinafter, a preferred embodiment of the present disclosure will be described with reference to the accompanying drawings. Further, in the following description of the present invention, a detailed description of known functions and configurations incorporated herein will be omitted when it may make the subject matter of the present invention rather unclear. The terms which will be described below are terms defined in consideration of the functions in the present disclosure, and may be different according to users, intentions of the users, or customs. Accordingly, the terms should be defined based on the contents over the whole present specification.

Hereinafter, embodiments of the present invention will be described by employing an Advanced-E UTRA (Evolved Universal Terrestrial Radio Access) (or referred to as LTE-A) system, which supports carrier aggregation, as one example. However, the embodiments of the present invention can also be applied to various communication systems having similar technical background and/or channel type. Furthermore, the embodiments of the present invention can also be applied to other communication systems through partial modification by the determination of those who skilled in the art without departing from the scope of the present invention. For example, a timing relation according to one aspect of one embodiment can be applied to a multicarrier HSPA system that supports the carrier aggregation.

Hereinafter, a base station is a subject that performs resource assignment of a terminal and may include at least one of an eNode B, a Node B, a BS (Base Station), a radio access unit, a base station controller, and a node on a network. The terminal may include at least one of UE (User Equipment), a MS (Mobile Station), a cellular phone, a smart phone, a computer, and a multimedia system capable of performing a communication function.

An LTE system employs a HARQ (Hybrid Automatic Repeat reQuest) scheme that retransmits corresponding data in a physical layer when decoding failure occurs in initial transmission. In the HARQ scheme, when a receiver does not exactly decode data, the receiver transmits information NACK, which reports decoding failure, to a transmitter, so that the transmitter can retransmit the corresponding data in a physical layer. The receiver combines the data retransmitted by the transmitter with the decoding-failed data, thereby improving data reception performance. Furthermore, when the receiver exactly decodes the data, the receiver transmits information ACK, which reports decoding success, to the transmitter, so that the transmitter can transmit new data.

One of technologies, which are important for providing a high speed radio data service in a cellular radio communication system, is to support scalable bandwidth. In one example, the LTE system can have various bandwidths of 20 MHz, 15 MHz, 10 MHz, 5 MHz, 3 MHz, 1.4 MHz and the like. Service providers can provide a service by selecting at least one of the bandwidths, and there exist various types of terminals that supplying a minimum 1.4 MHz bandwidth to a maximum 20 MHz bandwidth. In the LTE-A system, it is possible to provide a broadband service of a maximum 100 MHz bandwidth through carrier aggregation.

The LTE-A system needs a larger broadband in order to perform high speed data transmission as compared with the LTE system. Simultaneously, since backward compatibility for LTE terminals is important, the LTE terminals should access the LTE-A system and receive a service. To this end, in the LTE-A system, an entire system band is divided into subbands or component carriers (CCs) of a bandwidth in which LTE terminals can perform transmission or reception, predetermined component carriers are coupled with each other, and data is generated and transmitted by a component carrier, so that it is possible to support high speed data transmission of the LTE-A system by utilizing a transceiving process of an existing LTE system by a component carrier.

Scheduling information on data that is transmitted by a component carrier is reported to a terminal through downlink control information (DCI). The DCI may have various formats, and a predetermined DCI format is applied according to scheduling information on uplink data, scheduling information on downlink data, compact DCI, the application of spatial multiplexing using multiple antennas, DCI for power control, and the like. For example, DCI format 1, which is control information on downlink data employing no MIMO (Multiple Input Multiple Output) antenna, includes the following control information.
Resource allocation type 0/1 flag: Whether a resource allocation scheme is type 0 or type 1 is notified. In the type 0, a resource is allocated in units of RBG (resource block group) by using a bitmap scheme. In the LTE and LTE-A systems, a basic unit of scheduling is a RB (resource block) represented by time and frequency domain resources, and the RBG includes a plurality of RBs and serves as a basic unit of scheduling in the type 0 scheme. In the type 1, a specific RB is allocated in the RBG.
Resource block assignment: A RB assigned to data transmission is notified. A resource is determined according to a system bandwidth and a resource assignment scheme.
Modulation and coding scheme: A modulation scheme and a coding rate used in data transmission are notified.
HARQ process number: A process number of HARQ is notified.
New data indicator: HARQ initial transmission or retransmission is notified.
Redundancy version: Redundancy version of HARQ is notified.
TPC command for PUCCH: A power control command for a PUCCH (Physical uplink control channel), which is an uplink control channel, is notified.

DCI is subject to channel coding and modulation processes and is transmitted through a PDCCH (Physical downlink control channel) that is a downlink physical control channel.

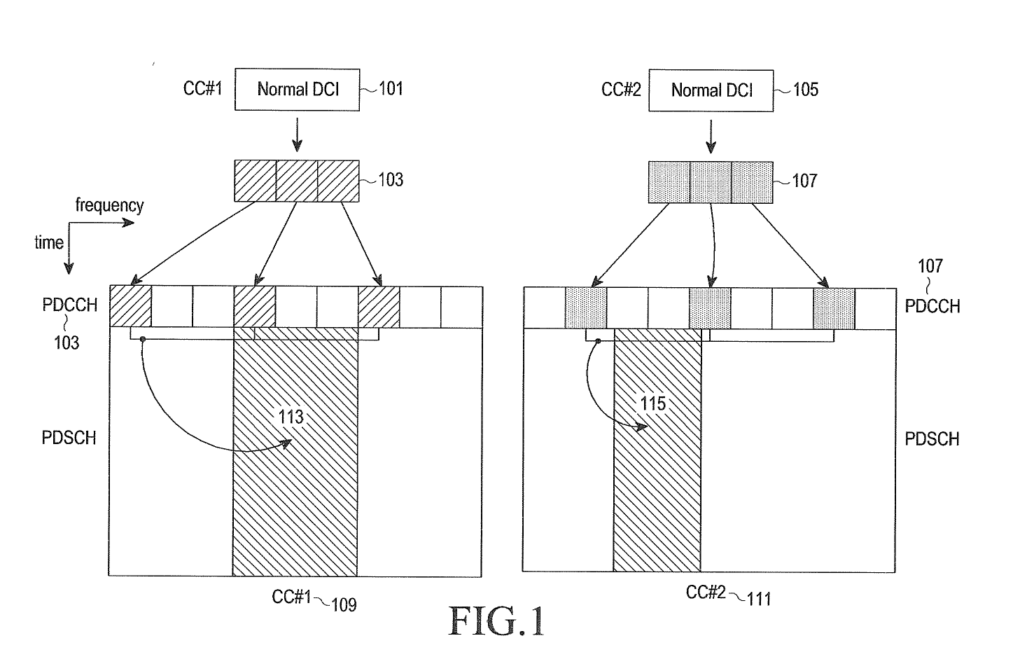

FIG. 1 is a diagram illustrating one example of scheduling of downlink data in a radio communication system. FIG. 1 illustrates the case in which a base station schedules downlink data to a teiminal in the LTE-A system in which two component carriers CC#1 and CC#2 have been coupled with each other.

Referring to FIG. 1, DCI 101 transmitted in the component carrier #1 (CC#1, 109) employs a format defined in the exiting LTE, is subject to channel coding and interleaving, and is used to generate a PDCCH 103. The PDCCH 103 informs a terminal of scheduling information on a PDSCH (Physical downlink shared channel) 213 that is a data channel assigned to the terminal in the CC#1 (109). DCI 105 transmitted in the component carrier #2 (CC#2, 111) employs a format defined in the exiting LTE, is subject to channel coding and interleaving, and is used to generate a PDCCH 107. The PDCCH 107 informs the terminal of scheduling information on a PDSCH 115 that is a data channel assigned to the terminal in the CC#2 (111).

In the LTE-A system that supports carrier aggregation, data transmission and the transmission of the downlink control information (DCI) for supporting the data transmission are basically performed by a corresponding component carrier as described in FIG. 1. Such a scheduling scheme is called self-scheduling. However, in the case of the DCI, in order to obtain high reliable reception performance of a terminal, data may be transmitted through a component carrier different from a transmitted component carrier, which is called cross carrier scheduling.

For example, in the example of FIG. 1, when it is difficult to expect high reliable reception performance of DCI because the component carrier #2 is affected by high interference, the DCI may be transmitted through the component carrier #1 relatively less affected by interference. In the case of a PDSCH for transmitting data, it is possible to overcome the influence of the interference by a method such as frequency selective scheduling or HARQ. However, in the case of a PDCCH for transmitting the DCI, since the HARQ is not applied, the DCI is transmitted over an entire system band, and it is not possible to apply the frequency selective scheduling, a countermeasure for overcoming the interference is required.

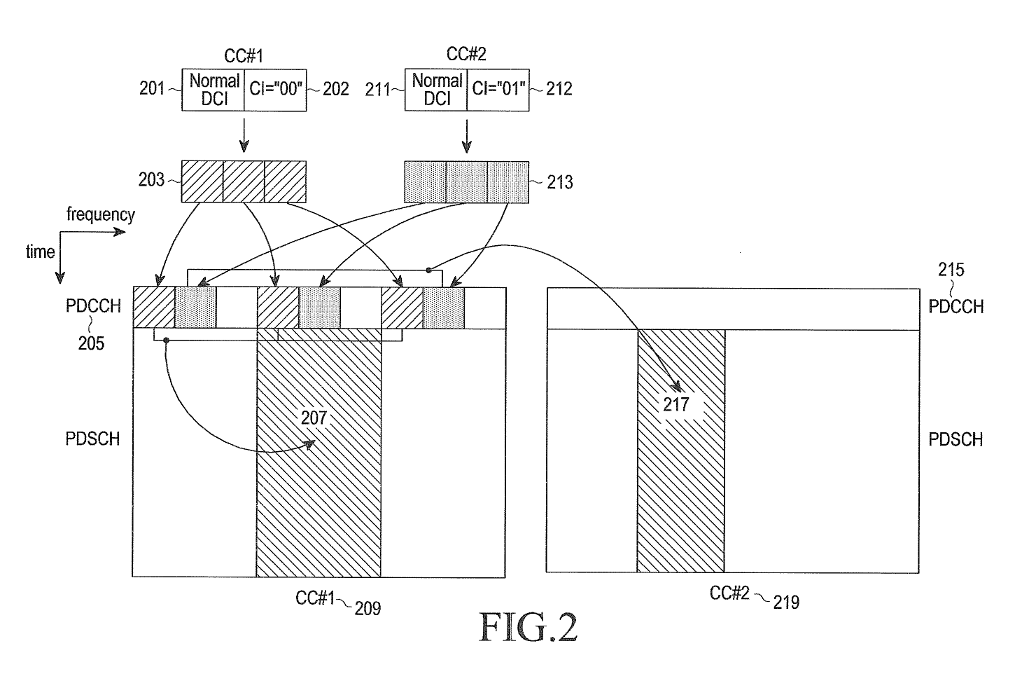

FIG. 2 is a diagram illustrating a detailed example for a cross carrier scheduling operation. Hereinafter, a description will be provided for a scheduling operation for an LTE-A terminal using carrier aggregation of a component carrier #1 (CC#1, 209) and a component carrier #2 (DL CC#2, 219).

FIG. 2 assumes that the case in which desired DCI reception performance is difficult to be satisfied when DCI representing scheduling information on data transmission of the CC#2 (219) is transmitted through the CC#2 (219) because the CC#2 (219) is relatively largely affected by downlink interference as compared with the CC#1 (209). In this case, a base station may transmit the DCI through the CC#1 (209).

In order to enable the cross carrier scheduling, the base station should add a carrier indicator (CI), which indicates scheduling information on a component carrier represented by DCI, to DCI representing resource allocation information, transmission type and the like of scheduled data, and transmit this DCI. For example, CI=‘00’ indicates scheduling information on the CC#1 (209) and CI=‘01’ indicates scheduling information on the CC#2 (219).

Accordingly, DCI 201 representing resource allocation information, transmission type and the like of data 207 scheduled to the CC#1 is combined with a carrier indicator 202 to configure extended DCI, and the extended DCI is subject to channel coding (203) to configure a PDCCH through modulation and interleaving, and is mapped to a PDCCH area 205 of the CC#1 for transmission. Then, DCI 211 representing resource allocation infoiniation, transmission type and the like of data 217 scheduled to the CC#2 is combined with a carrier indicator 212 to configure extended DCI, and the extended DCI is subject to channel coding (213) to configure a PDCCH through modulation and interleaving, and is mapped to a PDCCH area 205 of the CC#1 for transmission.

In the LTE and LTE-A TDD, an uplink signal or a downlink signal is separately transmitted by a subframe. In the LTE, the length of a subframe is 1 ms, and 10 subframes are gathered to configure one radio frame.

Table 1 below shows TDD uplink-downlink configuration defined in the LTE.

TABLE 1

| Uplink-downlink | Subframe number | | | | | | | | | |
|---|---|---|---|---|---|---|---|---|---|---|
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

In Table 1 above, the ‘D’ indicates a subframe set for downlink transmission, the ‘U’ indicates a subframe set for uplink transmission, and the ‘S’ indicates a special subframe including DwPTS (Dwonlink Pilot Time Slot), GP (Guard Period), and UpPTS (Uplink Pilot Time Slot). In the DwPTS, similarly to a general subframe, downlink control information transmission is possible, and downlink data transmission is also possible when the length of the DwPTS is sufficiently long according to a configuration state of the special subframe. The GP is a period in which the shift of a transmission signal from a downlink to an uplink is accepted, and has a length determined according to a network configuration and the like. The UpPTS is used for transmitting a SRS (Sounding Reference Signal) of a terminal required for estimating an uplink channel state or transmitting a RACH (Random Access Channel) of a terminal for random access.

For example, in the case of a TDD uplink-downlink configuration #6, downlink data and control information transmission in subframes #0, #5, and #9 is possible, and uplink data and control information transmission in subframes #2, #3, #4, #7, and #8 is possible. In subframes #1 and #6, corresponding to the special subframe, downlink control information transmission is possible and downlink data is possible according to situations, while uplink SRS or RACH transmission is also possible.

In the LTE and LTE-A TDD systems, the following is an uplink/downlink timing relation of a PDSCH (Physical Downlink Shared Channel), which is a physical channel for downlink data transmission, and a PUCCH (Physical Uplink Control Channel) or PUSCH (Physical Uplink Shared Channel), which corresponds to the PDSCH and is used to transmit uplink HARQ ACK/NACK.

When a PDSCH transmitted from a base station in a subframe n-k is received, a terminal performs uplink HARQ ACK/NACK transmission for the PDSCH in an uplink subframe n. The k is an element of a set K, and for example, the K is defined as shown in Table 2 below.

TABLE 2

| UL-DL | | | | | | | | | | |
|---|---|---|---|---|---|---|---|---|---|---|
| Config- | Subframe n | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, | — | — | — | — | 8, 7, 4, | — | — |
| | | | 6 | | | | | 6 | | |
| 3 | — | — | 7, 6, 11 | 6, 5 | 5, | — | — | — | — | — |
| | | | | | 4 | | | | | |
| 4 | — | — | 12, 8, 7, | 6, 5, 4, | — | — | — | — | — | — |
| | | | 11 | 7 | | | | | | |
| 5 | — | — | 13, 12, 9, | — | — | — | — | — | — | — |
| | | | 8, 7, 5, | | | | | | | |
| | | | 4, | | | | | | | |
| | | | 11, 6 | | | | | | | |
| 6 | — | — | 7 | 7 | 5 | — | — | 7 | 7 | — |

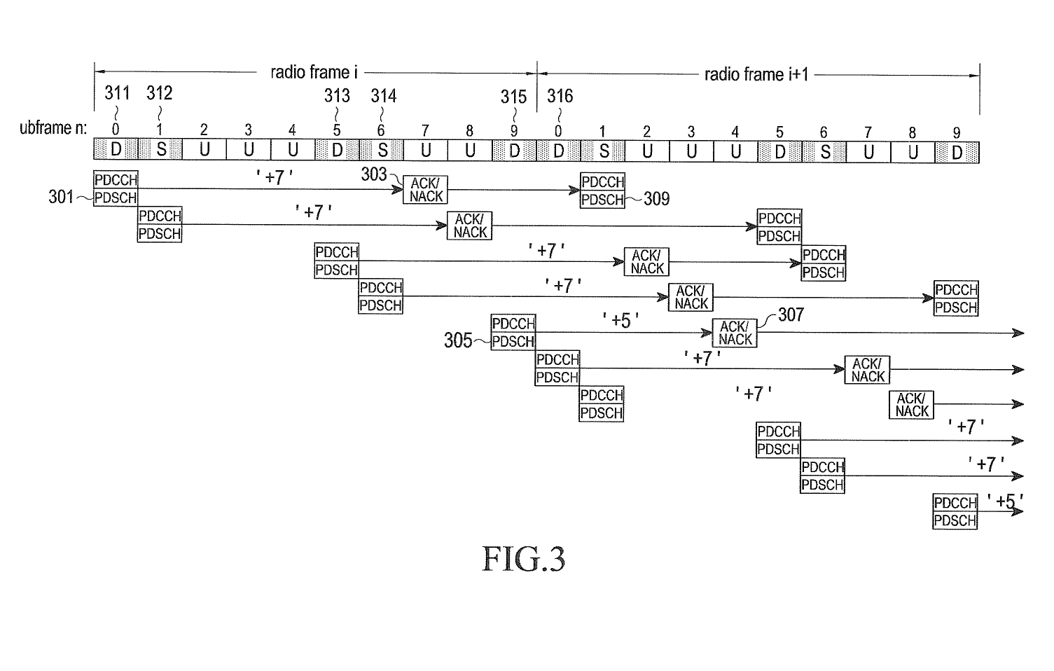

FIG. 3 is a diagram illustrating a timing of uplink HARQ ACK/NACK for a PDSCH in the TDD radio communication system. In detail, in the case of the TDD uplink-downlink configuration #6, when a PDSCH is transmitted in each downlink or special subframe, subframes in which uplink HARQ ACK/NACK corresponding to data of the PDSCH is transmitted will be described according to the definition of Table 2 above.

Referring to FIG. 3, uplink HARQ ACK/NACK 303, which corresponds to a PDSCH 301 transmitted by a base station in a subframe #0 of a radio frame i, is transmitted from a terminal in a subframe #7 of the radio frame i. At this time, downlink control information (DCI) including scheduling information on the PDSCH 301 is transmitted through a PDCCH in the same subframe as that in which the PDSCH 301 is transmitted.

Furthermore, uplink HARQ ACK/NACK 307, which corresponds to a PDSCH 305 transmitted by the base station in a subframe #9 of the radio frame i, is transmitted from the terminal in a subframe #4 of a radio frame i+1. Similarly, downlink control information (DCI) including scheduling information on the PDSCH 305 is transmitted through a PDCCH in the same subframe as that in which the PDSCH 305 is transmitted.

The LTE and LTE-A systems employ an asynchronous HARQ scheme in which a point of time of retransmission of downlink HARQ data is not fixed. That is, when HARQ NACK for HARQ initial transmission data transmitted by a base station is fedback from a terminal, the base station freely determines a point of time of transmission of next HARQ retransmission data by a scheduling operation. As a result obtained by decoding received data for a HARQ operation, the terminal buffers HARQ data determined as an error, and combines the buffered data with next HARQ retransmission data. At this time, in order to maintain a reception buffer capacity of the terminal to a fixed limit, the maximum number of downlink HARQ processes may be defined by a TDD uplink-downlink configuration. One HARQ process is mapped to one subframe in a time domain.

Table 3 below shows one example for the mapping of the maximum number of downlink HARQ processes corresponding to a TDD uplink-downlink configuration.

TABLE 3

| | Maximum number of HARQ |
|---|---|
| TDD UL/DL configuration | processes |
| 0 | 4 |
| 1 | 7 |
| 2 | 10 |
| 3 | 9 |
| 4 | 12 |
| 5 | 15 |
| 6 | 6 |

Referring to the example of FIG. 3, when the terminal determines a decoding result of the PDSCH 301 transmitted by the base station in the subframe #0 of the radio frame i as an error, the terminal transmits the HARQ NACK 303 in the subframe #7 of the radio frame i. When the HARQ NACK 303 is received, the base station configures retransmission data for the PDSCH 301 as a PDSCH 309, and transmits the PDSCH 309 together with a PDCCH.

The example of FIG. 3 illustrates the case in which retransmission data is transmitted in a subframe #1 of the radio frame i+1 by reflecting the fact that the maximum number of downlink HARQ processes of the TDD uplink-downlink configuration #6 is 6 according to the definition of Table 3 above. That is, there exist a total of six downlink HARQ processes 311, 312, 313, 314, 315, and 316 between the initial transmission PDSCH 301 and the retransmission PDSCH 309.

In the LTE system, differently from the downlink HARQ, uplink HARQ employs a synchronous HARQ scheme in which a point of time of data transmission is fixed. That is, a timing relation among a PUSCH (Physical Uplink Shared Channel), which is a physical channel for uplink data transmission, a PDCCH, which is a downlink control channel prior to the PUSCH, and a PHICH (Physical Hybrid Indicator Channel), which is a physical channel for transmitting downlink HARQ ACK/NACK corresponding to the PUSCH, is fixed by the following rules.

In the case of receiving a PDCCH including DCI format 0 that is uplink scheduling control information transmitted from the base station in a subframe n, or a PHICH through which downlink HARQ ACK/NACK is transmitted, the terminal transmits uplink data corresponding to the control information in a subframe n+k through the PUSCH. In one example, the k may be defined as shown in Table 4 below.

TABLE 4

| TDD UL/DL | DL subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Then, when the terminal receives the PHICH for carrying the downlink HARQ ACK/NACK from the base station in the subframe i, the PHICH corresponds to a PUSCH transmitted by the terminal in a subframe i-k. In this case, the k may be defined as shown in Table 5 below for example.

TABLE 5

| TDD UL/DL | DL subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

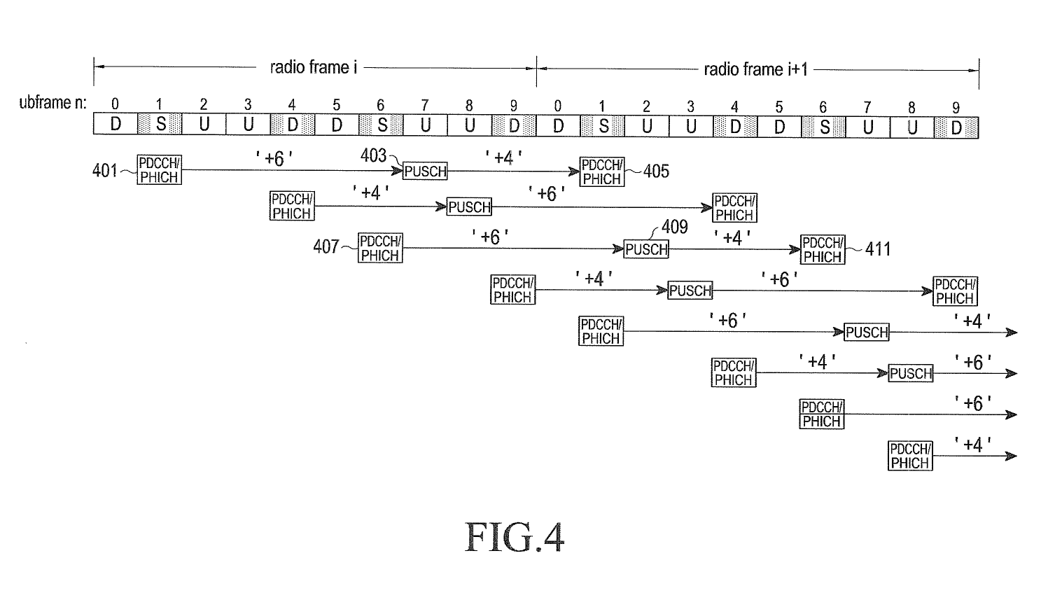

FIG. 4 is a diagram illustrating a timing relation of a PHICH corresponding to an uplink PUSCH in the TDD radio communication system. In detail, in the case of a TDD uplink-downlink configuration #1, when a PDCCH or a PHICH is transmitted in each downlink or each special subframe, a subframe, in which an uplink PUSCH corresponding to the PDCCH or the PHICH is transmitted, and a subframe, in which a PHICH corresponding to the PUSCH is transmitted, are shown according to the definitions of Table 4 and Table 5 above.

Referring to FIG. 4, an uplink PUSCH 403, which corresponds to a PDCCH or PHICH 401 transmitted by the base station in a subframe #1 of a radio frame i, is transmitted from the terminal in a subframe #7 of the radio frame i. Then, the base station transmits a PHICH 405 corresponding to the PUSCH 403 to the terminal in a subframe #1 of a radio frame i+1.

Furthermore, an uplink PUSCH 409, which corresponds to a PDCCH or PHICH 407 transmitted by the base station in a subframe #6 of the radio frame i, is transmitted from the terminal in a subframe #2 of a radio frame i+1. Then, the base station transmits a PHICH 411 corresponding to the PUSCH 409 to the terminal in a subframe #6 of the radio frame i+1.

The LTE TDD system allows downlink transmission of a PDCCH or a PHICH corresponding to a PUSCH to be limited in a special downlink subframe in relation to the PUSCH transmission, thereby ensuring minimum transceiving processing times of a base station and a terminal. For example, in the case of the TDD uplink-downlink configuration #1 of FIG. 4, a PDCCH for scheduling a PUSCH or a PHICH corresponding to a PUSCH is not transmitted to a downlink in subframes #0 and #5.

As described above, the scheduling operation, which controls a component carrier for transmitting the downlink control information (DCI) for supporting data transmission to be different from a component carrier for transmitting uplink or downlink data scheduled by the DCI, is called the cross carrier scheduling. Differently from this, the scheduling operation, which controls the component carrier for transmitting the downlink control information (DCI) for supporting data transmission to be the same as the component carrier for transmitting uplink or downlink data scheduled by the DCI, is called the self-scheduling.

In the LTE-A system that supports the carrier aggregation, when coupled component carriers are not adjacent to one another in a frequency band and the occurrence probability of an interference problem among the coupled component carriers is low, the TDD uplink-downlink configurations may be set to differ by a component carrier according to a system operation scenario.

For example, a first component carrier may be operated by uniformly dividing uplink/downlink subframes in a time domain, and a second component carrier may be operated by assigning many more downlink subframes and expanding a downlink capacity. In another example, in consideration of the compatibility with the TD-SCDMA that is the existing 3G TDD system, the first component carrier may apply a TDD uplink-downlink configuration compatible with the TD-SCDMA system and prevent a mutual interference problem between the TD-SCDMA system and the LTE TDD system, and the second component carrier may be operated by determining a TDD uplink-downlink configuration according to traffic load without separate limitations.

Hereinafter, a carrier aggregation system including a primary cell Pcell and a secondary cell Scell will be described. The Pcell is operated in a primary frequency (or a primary component carrier (PCC)) to provide a terminal with a basic radio resource, so that the terminal performs an initial connection operation, a handover operation and the like. The Scell is added to the Pcell in a secondary frequency (or a Secondary Component Carrier (SCC)) to be operated as an additional radio resource assigned to a terminal. Typically, the HARQ ACK/NACK fedback to a base station from a terminal includes a PUCCH that is a physical control channel for transmitting control information and is transmitted through the Pcell.

Furthemiore, a terminal operates as a half-duplex terminal capable of performing only one of a downlink signal reception operation and an uplink signal transmission operation at a certain point of time, that is, capable of not performing the downlink signal reception operation and the uplink signal transmission operation at the same time.

In the TDD radio communication system that achieves a broadband through the carrier aggregation, when TDD uplink-downlink configurations of coupled carriers differ by a carrier, it is necessary to define a method in which a terminal performing a half-duplex operation receives a downlink signal or transmits an uplink signal at a point of time at which a specific time slot has been set as a downlink subframe or a special subframe in one component carrier and has been set as an uplink subframe in another component carrier coupled with the component carrier.

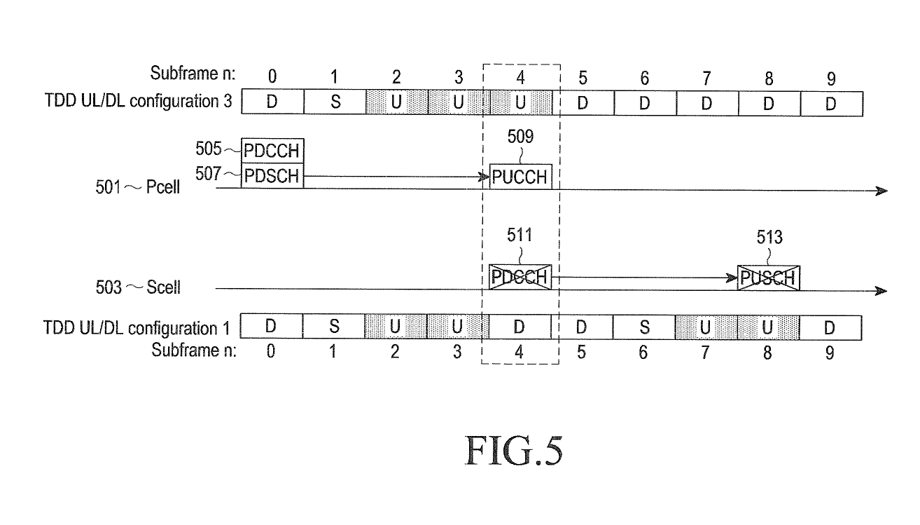

FIG. 5 is a diagram illustrating a transceiving relation of a half-duplex terminal when the TDD uplink and downlink configurations of the coupled carriers differ by a carrier according to one embodiment of the present invention.

Referring to FIG. 5, a Pcell 501 has a TDD uplink-downlink configuration #3 and a Scell 503 has a TDD uplink-downlink configuration #1. When a base station transmits a PDSCH 507 to be transmitted in a subframe #0 by the Pcell and a PDCCH 505 for scheduling the PDSCH 507, a transmission timing of HARQ ACK/NACK corresponding to the PDSCH 507 is a subframe #4 according to a timing relation defined for the TDD uplink-downlink configuration #3 of Table 2 for example, and a terminal transmits HARQ ACK/NACK through the Pcell (509).

In this case, when the base station intends to schedule a PUSCH 513 to be transmitted in a subframe #8 of the Scell, the base station transmits a PDCCH 511 for scheduling the PUSCH 513 in the subframe #4 of the Scell according to a timing relation defined for the TDD uplink-downlink configuration #1 of Table 4 for example.

However, since a half-duplex terminal is not able to simultaneously perform downlink signal reception and uplink signal transmission in the subframe #4, it is necessary to define priority for transceiving signals.

In the example of FIG. 5, a point of time of transmission of the PUCCH that is an uplink signal and a point of time of transmission of the PDCCH that is a downlink signal are overlapped with each other in a predetermined time slot (that is, one subframe), the PUCCH has transmission priority. This is because a PUCCH to be transmitted in the subframe #4 of the Pcell is an uplink signal including a HARQ ACK/NACK signal representing whether a terminal successfully receives a PDSCH transmitted prior to the subframe #4, and is necessary in order to perform a HARQ operation. Accordingly, a point of time of transmission of a PDCCH for scheduling a PUSCH of the Scell to be transmitted after the subframe #4 is adjusted not to be overlapped with the subframe #4 in which the PUCCH is to be transmitted, according to the scheduling determination of a base station.

Accordingly, when a PDSCH is received in the subframe #0 of the Pcell, a terminal transmits a PUCCH corresponding to the PDSCH in the subframe #4 of the Pcell, and does not receives a downlink signal in the subframe #4 of the Scell.

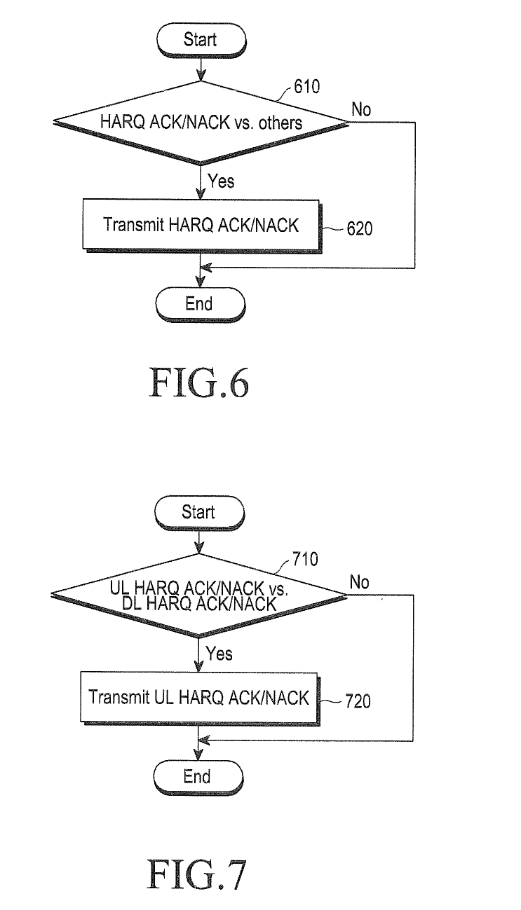

The priority (priority 1) of an uplink or downlink signal of the half-duplex terminal is as illustrated in FIG. 6 and FIG. 7.

Referring to FIG. 6, when a point of time of transmission of HARQ ACK/NACK in the component carrier #1 and a point of time of transmission of another signal in the component carrier #2 coupled with the component carrier #1 are overlapped with each other (610), a terminal transmits or receives a HARQ ACK/NACK signal through the component carrier #1 (620). The HARQ ACK/NACK is transmitted from the terminal through a PUCCH that is an uplink control channel, or is included in a PUSCH that is an uplink data channel and then is transmitted from the terminal. Alternatively, the HARQ ACK/NACK may be received in the terminal through a PHICH that is a downlink HARQ ACK/NACK control channel.

Referring to FIG. 7, when a point of time of reception of uplink HARQ ACK/NACK and a point of time of reception of downlink HARQ ACK/NACK are overlapped with each other (710), a terminal transmits the HARQ ACK/NACK through an uplink (720). Since the HARQ ACK/NACK transmitted through the uplink may include a plurality of HARQ ACK/NACKs corresponding to PDSCHs transmitted from a plurality of component carriers differently from the HARQ ACK/NACK received through a downlink, the priority of the HARQ ACK/NACK transmitted through the uplink is increased to minimize the amount of information loss.

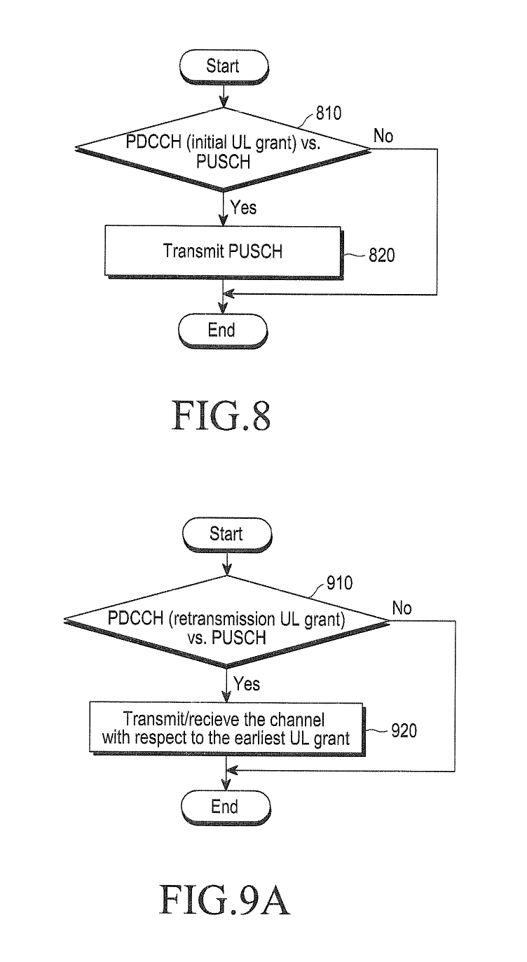

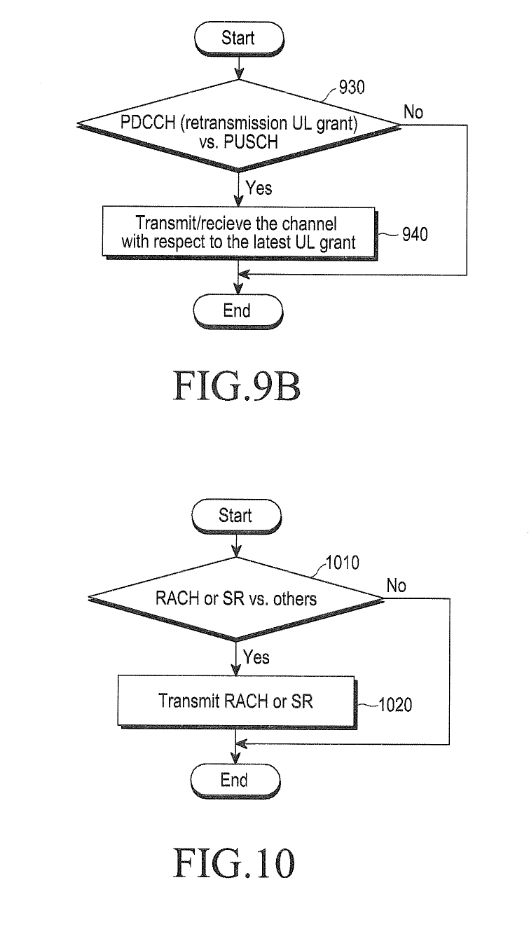

When a point of time of transmission of a PDCCH that is a downlink control channel for scheduling a PUSCH in the component carrier #1 and a point of time of transmission of a PUSCH that is an uplink data channel in the component carrier #2 coupled with the component carrier #1 are overlapped with each other, a terminal follows priority (priority 2) illustrated in FIG. 8, FIG. 9a, and FIG. 9b. At this time, the PDCCH scheduling the PUSCH is transmitted prior to a k^{th} (k is a positive integer) subframe than the point of time of transmission of the PUSCH.

Referring to FIG. 8, when the PDCCH of the component carrier #1 schedules initial transmission of the PUSCH of the component carrier #1 (810), a terminal transmits the PUSCH of the component carrier #2 (820). This is to follow a timer order because scheduling determination of a base station for the PUSCH of the component carrier #2 is performed before scheduling determination for the PUSCH of the component carrier #1.

Referring to FIG. 9a, when the PDCCH of the component carrier #1 schedules retransmission of the PUSCH of the component carrier #1 (910), a terminal compares a point of time of transmission of a PDCCH having initially scheduled the PUSCH of the component carrier #1 with a point of time of transmission of a PDCCH having initially scheduled the PUSCH of the component carrier #2, and receives or transmits a signal of a component carrier corresponding to an advanced point of time (920). That is, when PUSCH transmission is started, the terminal preferentially processes an operation for transceiving signals related to the PDCCH and the PUSCH until success transmission of the corresponding PUSCH is completed. Thus, priority is applied to a service generated in advance.

In a modified example of the priority 2, when a point of time of transmission of a PDCCH that is a downlink control channel for scheduling a PUSCH in the component carrier #1 and a point of time of transmission of a PUSCH that is an uplink data channel in the component carrier #2 coupled with the component carrier #1 are overlapped with each other, a terminal follows priority (priority 2-1) illustrated in FIG. 9A. As described above, the PDCCH scheduling the PUSCH is transmitted prior to a k^{th} (k is a positive integer) subframe than the point of time of transmission of the PUSCH.

Referring to FIG. 9b, when the PDCCH of the component carrier #1 schedules retransmission of the PUSCH of the component carrier #1 (930), a terminal compares a point of time of transmission of a PDCCH having initially scheduled the PUSCH of the component carrier #1 with a point of time of transmission of a PDCCH having initially scheduled the PUSCH of the component carrier #2, and receives or transmits a signal of a component carrier corresponding to the most recent point of time (940). That is, the terminal determines that the scheduling of a base station at the most recent point of time is effective, and operates according to the determination.

Accordingly, even though a PUSCH generated in advance is running in the component carrier #1 at the present time, when a base station transmits a PDCCH for scheduling the PUSCH of the component carrier #2, the terminal transmits the PUSCH of the component carrier #2 according to the PDCCH.

When a point of time, at which a terminal transmits a RACH for performing random access or SR (Scheduling Request) for scheduling request in the component carrier #1, and a point of time, at which the terminal receives a downlink signal in the component carrier #2, are overlapped with each other, the terminal follows priority (priority 3) illustrated in FIG. 10.

Referring to FIG. 10, when a point of time of transmission of a RACH or a SR that is an uplink signal in the component carrier #1 and a point of time of transmission of a downlink signal in the component carrier #2 are overlapped with each other (1010), a terminal transmits the RACH or the SR of the component carrier #1 (1020). A preliminary transmission resource, by which the terminal can transmit the RACH or the SR, is reported from a base station to the terminal. Since the terminal is difficult to estimate in advance whether the downlink signal exists at a point of time at which the RACH or the SR is determined to be transmitted, priority is applied to the transmission of the RACH or the SR by the terminal.

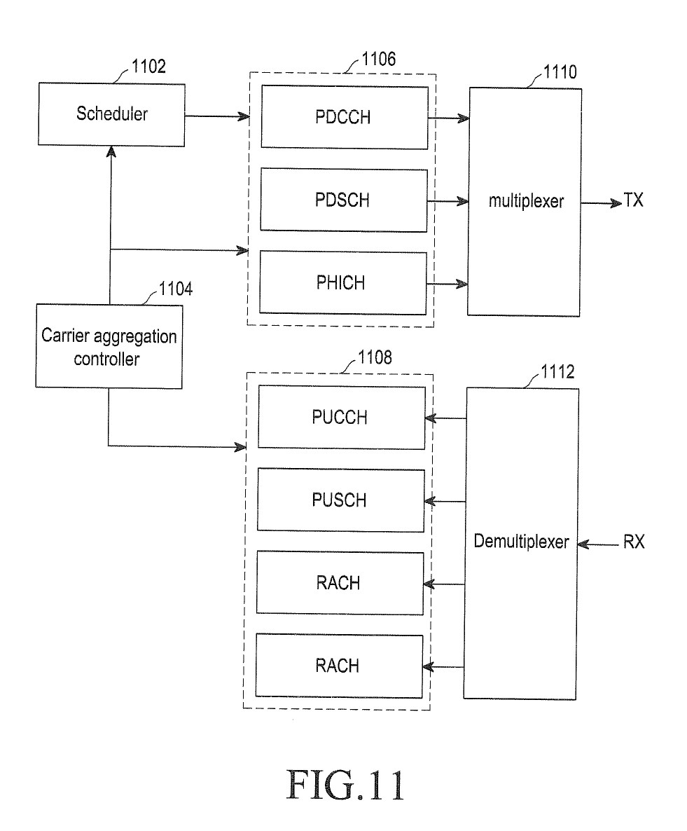

FIG. 11 illustrates a base station device according to one embodiment of the present invention.

Referring to FIG. 11, the base station device includes a transmission physical channel block 1106 configured to generate signals of a PDCCH, a PDSCH, and a PHICH, a transmission unit including a multiplexer 1110, a reception physical channel block 1108 configured to demodulate and decode signals of a PUCCH, a PUSCH, a RACH, and a SR, a reception unit including a demultiplexer 1112, a carrier aggregation controller 1104, and a scheduler 1102.

The carrier aggregation controller 1104 adjusts the presence or absence of carrier aggregation for a terminal intended to perform scheduling and a priority relation among respective physical channels by referring to the amount of data to be transmitted to a terminal, the amount of a resource available in the system, and the like, and informs the scheduler 1102 and the transmission/reception physical channel blocks 1106 and 1108 of the adjusted result. The priority relation follows the aforementioned detailed embodiments. Physical channel signals multiplexed by the multiplexer 1110 are generated as OFDM signals and transmitted to a terminal.

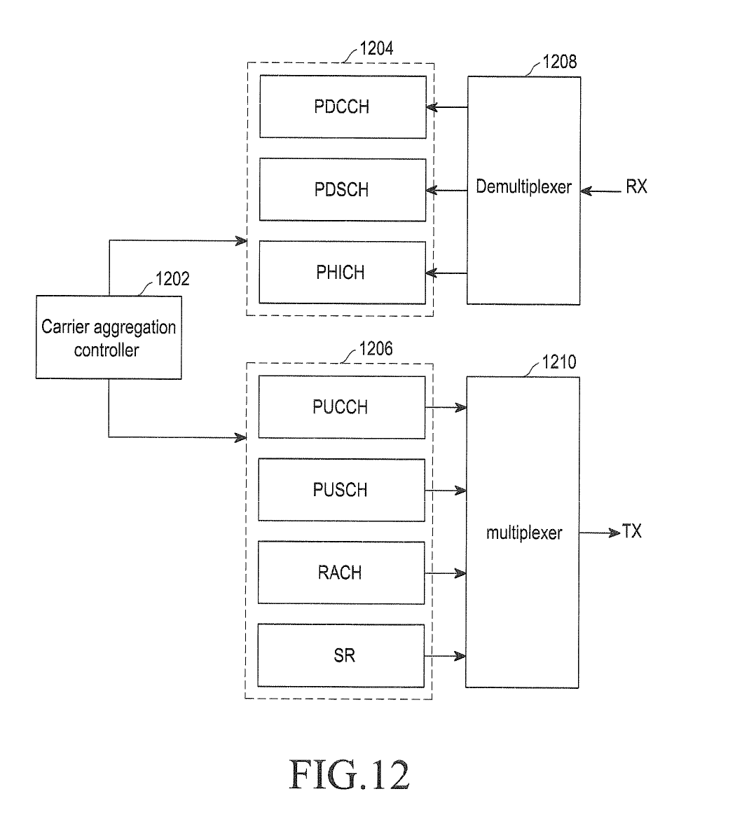

FIG. 12 illustrates a terminal device according to one embodiment of the present invention.

Referring to FIG. 12, the terminal includes a transmission physical channel block 1206 configured to generate signals of a PUCCH, a PUSCH, a RACH, and a SR, a transmission unit including a multiplexer 1210, a reception physical channel block 1204 configured to demodulate and decode signals of a PDCCH, a PDSCH, and a PHICH, a reception unit including a demultiplexer 1208, and a carrier aggregation controller 1202. The carrier aggregation controller 1202 adjusts a carrier aggregation state of the terminal from DCI received from a base station, adjusts the reception or non-reception of a PDSCH from a carrier in the cross carrier scheduling and a priority relation among respective physical channels, and informs the transmission/reception physical channel blocks 1204 and 1206 of the adjusted result. The priority relation follows the aforementioned detailed embodiments.

Although specific exemplary embodiments have been described in the detailed description of the present disclosure, various change and modifications may be made without departing from the spirit and scope of the present disclosure. Therefore, the scope of the present disclosure is not limited to the embodiment described above, and should be defined by the accompanying claims and the equivalents of the claims.

1. A method for controlling transceiving of a physical channel in a time division duplex (TDD) communication system, comprising the steps of:
determining whether a point of time of transmission of hybrid automatic retransmission request (HARQ) ACK/NACK in a component carrier #1 and a point of time of transmission of another signal in a component carrier #2 coupled with the component carrier #1 are overlapped with each other; and
preferentially transmitting or receiving the HARQ ACK/NACK when the points of time of transmission are overlapped with each other.

2. A method for controlling transceiving of a physical channel in a time division duplex (TDD) communication system, comprising the steps of:
determining whether a point of time of transmission of uplink HARQ ACK/NACK and a point of time of reception of downlink HARQ ACK/NACK are overlapped with each other; and
preferentially transmitting the uplink HARQ ACK/NACK when the points of time of transmission are overlapped with each other.

3. A method for controlling transceiving of a physical channel in a time division duplex (TDD) communication system, comprising the steps of:
determining whether a point of time of transmission of a physical downlink control channel (PDCCH) for scheduling a physical uplink shared channel (PUSCH) in a component carrier #1 and a point of time of transmission of a PUSCH in a component carrier #2 coupled with the component carrier #1 are overlapped with each other; and
preferentially transmitting the PUSCH of the component carrier #2 when the points of time of transmission are overlapped with each other and the PDCCH of the component carrier #1 schedules initial transmission of the PUSCH of the component carrier #1.

4. A method for controlling transceiving of a physical channel in a time division duplex (TDD) communication system, comprising the steps of:
determining whether a point of time of transmission of a PDCCH, which is a downlink control channel for scheduling a PUSCH in a component carrier #1 and a point of time of transmission of a PUSCH, which is an uplink data channel, in a component carrier #2 coupled with the component carrier #1 are overlapped with each other; and
comparing a point of time of transmission of a PDCCH having initially scheduled the PUSCH of the component carrier #1 with a point of time of transmission of a PDCCH having initially scheduled the PUSCH of the component carrier #2, and receiving or transmitting a signal of a component carrier corresponding to an advanced point of time or a recent point of time when the points of time of transmission are overlapped with each other and the PDCCH of the component carrier #1 schedules retransmission of the PUSCH of the component carrier #1.

5. A method for controlling transceiving of a physical channel in a time division duplex (TDD) communication system, comprising:
determining whether a point of time of transmission of a random access channel (RACH) or a scheduling request (RS) in a component carrier #1 and a point of time of reception of a downlink signal in a component carrier #2 are overlapped with each other; and
transmitting the RACH or the SR of the component carrier #1 when the points of time are overlapped with each other.

6. An apparatus for controlling transceiving of a physical channel in a time division duplex (TDD) communication system, comprising:
a controller that determines whether a point of time of transmission of hybrid automatic retransmission request (HARQ) ACK/NACK in a component carrier #1 and a point of time of transmission of another signal in a component carrier #2 coupled with the component carrier #1 are overlapped with each other; and
a transceiving unit that preferentially transmits or receives the HARQ ACK/NACK when the points of time of transmission are overlapped with each other.

7. An apparatus for controlling transceiving of a physical channel in a time division duplex (TDD) communication system, comprising:
a controller that determines whether a point of time of transmission of uplink HARQ ACK/NACK and a point of time of reception of downlink HARQ ACK/NACK are overlapped with each other; and
a transceiving unit that preferentially transmits the uplink HARQ ACK/NACK when the points of time of transmission and reception are overlapped with each other.

8. An apparatus for controlling transceiving of a physical channel in a time division duplex (TDD) communication system, comprising:
a controller that determines whether a point of time of transmission of a physical downlink control channel (PDCCH) for scheduling a physical uplink data channel (PUSCH) in a component carrier #1 and a point of time of transmission of a PUSCH in a component carrier #2 coupled with the component carrier #1 are overlapped with each other; and
a transceiving unit that preferentially transmits the PUSCH of the component carrier #2 when the points of time of transmission are overlapped with each other and the PDCCH of the component carrier #1 schedules initial transmission of the PUSCH of the component carrier #1.

9. An apparatus for controlling transceiving of a physical channel in a time division duplex (TDD) communication system, comprising:
a controller that determines whether a point of time of transmission of a PDCCH, which is a downlink control channel for scheduling a PUSCH in a component carrier #1 and a point of time of transmission of a PUSCH, which is an uplink data channel, in a component carrier #2 coupled with the component carrier #1 are overlapped with each other; and
a transceiving unit that compares a point of time of transmission of a PDCCH having initially scheduled the PUSCH of the component carrier #1 with a point of time of transmission of a PDCCH having initially scheduled the PUSCH of the component carrier #2, and receives or transmits a signal of a component carrier corresponding to an advanced point of time or a recent point of time when the points of time of transmission are overlapped with each other and the PDCCH of the component carrier #1 schedules retransmission of the PUSCH of the component carrier #1.

10. An apparatus for controlling transceiving of a physical channel in a time division duplex (TDD) communication system, comprising:
a controller that determines whether a point of time of transmission of a random access channel (RACH) or a scheduling request (RS) in a component carrier #1 and a point of time of reception of a downlink signal in a component carrier #2 are overlapped with each other; and
a transceiving unit that transmits the RACH or the SR of the component carrier #1 when the points of time are overlapped with each other.
